(19) United States
(12) Patent Application Publication
(10) Pub. No.: US 2005/0261389 A1
(43) Pub. Date: Nov. 24, 2005

(54) Low refractive index coating composition

(75) Inventors: Svetlana Bratolavsky, Elgin, IL (US); Timothy Bishop, Algonquin, IL (US); John E. Southwell, Elgin, IL (US)

Correspondence Address: MAYER, BROWN, ROWE & MAW LLP, 1909 K STREET, N.W., WASHINGTON, DC, 20006, US

(73) Assignee: DSM IP Assets B.V., Heerlen (NL)

(21) Appl. No.: 11/110,905

(22) Filed: Apr. 21, 2005

Related U.S. Application Data
(60) Provisional application No. 60/578,902, filed on Jun. 14, 2004.
(60) Provisional application No. 60/580,137, filed on Jun. 17, 2004.
(60) Provisional application No. 60/564,294, filed on Apr. 22, 2004.

(51) Int. Cl. C08K 3/00

(52) U.S. Cl. 522/71

(57) ABSTRACT

The present invention relates to radiation curable coating compositions, to coatings formed by curing these compositions, to processes for preparing such coatings, to articles comprising such coatings, and to antireflective coating systems. An aspect of the invention concerns the application of such coatings to hardcoats or display systems.

### CROSS REFERENCE TO RELATED APPLICATIONS

This application claims the benefit of U.S. Provisional Ser. No. 60/578,902, filed Jun. 14, 2004, and U.S. Provisional Ser. No. 60/580,137, filed Jun. 17, 2004, and U.S. Provisional Ser. No. 60/564,294, filed Apr. 22, 2004. These applications, in their entirety, are incorporated herein by reference.

### FIELD OF THE INVENTION

The present invention relates to radiation curable coating compositions, to coatings formed by curing these compositions, to processes for preparing such coatings and coating compositions, to articles comprising such coatings, and to antireflective coating systems. An aspect of the invention concerns the application of such coatings to hardcoats or display systems.

### BACKGROUND OF THE INVENTION

A large number of attempts have been made to develop coating compositions, yet despite such attempts much interest remains in the development of coating composition used for preparing low refractive index coating layers with good surface hardness, scratch resistance, abrasion resistance and good curability at low film thickness.

Previous attempts at producing low refractive index coatings have involved a wide array of additives and composition formulations. For example, U.S. Pat. No. 6,391,459 discusses a radiation curable composition containing a fluorinated urethane oligomer. Additionally, reactive silica nanoparticles, such as those described in U.S. Pat. No. 6,160,067, that incorporate a polymerizable unsaturated group, have been developed.

Of particular interest in the art of low refractive index coatings are thin coatings, e.g., those coatings that are less than 1 μm thick. Although the subject of much interest, traditional attempts to prepare such compositions have been thwarted by the presence of air, which is thought to impede proper curing of the composition. Therefore, the industrial production of such coatings has been limited by the requirement that these compositions be cured in an inert or less reactive environment. Accordingly, a low refractive index coating which may be applied in a thin layer and cured in air, while still affording good surface hardness, scratch resistance and abrasion resistance would be of great value in the coating industry.

### SUMMARY OF THE INVENTION

The present invention provides, inter alia, radiation curable coating compositions for forming low refractive index coatings. In particular, the coating compositions of the present invention are useful for forming thin coating layers in anti-reflective coating systems. The coating compositions of the present invention are capable of forming thin layer coatings that can be cured in air or oxygen containing environments. In addition, the present invention relates to processes for preparing such coatings and coating compositions, to articles and to antireflective coating systems comprising these coating compositions and/or coatings.

An embodiment of the present invention includes radiation curable coating compositions that are fast curing in air, for example, thin coatings (particularly those that are thinner than 1 micron) and/or low refractive index coatings. A particular embodiment of the radiation curable coating compositions of the present application include those capable of being cured at low radiation exposure in thin layers and result in a low refractive index coating suitable for anti-reflective systems.

One embodiment of the present invention is a radiation curable coating composition comprising an acrylate having greater than 2 acrylate groups, at least one component having at least one covalent fluorine bond and at least 6 wt. % photo-initiator.

Another embodiment of the present invention provides radiation curable coating compositions comprising, when cured in air, the following properties:
a. a 95% Relative RAU Dose of no greater than 0.7 J/cm² at a coating thickness less than 1.0 μm;
b. a pencil hardness of greater than or equal to H; and
c. a refractive index of less than 1.55.

Another embodiment of the present invention provides a process of making fast-curing, thin, low-refractive index coating compositions comprising mixing an acrylate having greater than 2 acrylate groups, at least one component having at least one covalent fluorine bond and at least 6 wt. % photoinitiators.

Further embodiments of the present invention also provide for articles comprising low refractive index coatings, hard coats with low refractive index properties and/or thin coating layers that are suitable for use in a variety of applications, such as coatings for optical fibers, photonics crystal fibers, inks and matrices, optical media, and displays.

Another aspect of the invention concerns the use of the present compositions to form coatings on substrates including for example display monitors (like flat screen computer and/or television monitors such as those utilizing technology discussed in, for example, U.S. Pat. Nos. 6,091,184 and 6,087,730 which are both hereby incorporated by reference), optical discs, touch screens, smart cards, flexible glass and the like.

In addition, the radiation curable composition of the present invention would be suitable for plastic substrates, for instance, those used in LCD (liquid crystal display), OLED (organic light emitting diode) display, plasma displays, CRT displays, or other flat panel or low profile display or display filters.

Additional objects, advantages and features of the present invention are set forth in this specification, and in part will become apparent to those skilled in the art on examination of the following, or may be learned by practice of the invention. The invention disclosed in this application is not limited to any particular set of or combination of objects, advantages and features but may be adapted within the teachings set forth herein and the general knowledge to optimize and/or comply with particular design criteria.

### DESCRIPTION OF THE INVENTION

Herein, certain terms, unless specified otherwise, are used to define certain chemical groups and compounds. These terms are defined below.

“Air” refers to a gaseous environment having greater than 15 wt. % oxygen.

“Nanoparticles” refers to a particle mixture wherein the majority of particles in the mixture have a dimension below 1 μm.

“Reactive Nanoparticle” refers to a nanoparticle having at least one reactive group (e.g., a polymerizable group).

“Dimension of a nanoparticle” (or “size of a nanoparticle”) refers to the diameter of the particles. For non-spherical particles, it refers to the longest dimension of a cross-section of the particle (i.e., the longest straight line that can be drawn from one side of the cross-section of the nanoparticle to the opposite side).

“(Meth)acrylate” refers to acrylate, and/or methacrylate, and substitutes thereof, preferably acrylate and methacrylate.

Radiation curable coating compositions of the present invention may include acrylates having greater than 2 acrylate groups, and components having at least one covalent fluorine bond.

Acrylates Having Greater than Two Acrylate Groups

Acrylates having greater than 2 acrylate groups is understood to include either a single chemical species that has more than 2 (meth)acrylate moieties (for example, 3, 4, 5, or 6 acrylate groups), or a mixture of one or more acrylate compounds that has, on average, more than 2 (meth)acrylate moieties, for example greater than 2.1, 2.3, 2.5, 2.7, 3.0, 3.5, 4.0, 4.5, 5.0 or 5.5 acrylate groups. A (meth)acrylate moiety may or may not be substituted.

Examples of acrylates having greater than two acrylate groups that may be used in the radiation curable coating compositions of the present application include the following compounds commercially available from the Sartomer Company, Inc.: SR9035—ethoxylated (15) trimethylolpropane triacrylate; SR454—ethoxylated (3) trimethylolpropane triacrylate; SR454HP—ethoxylated (3) trimethylolpropane triacrylate; SR499—ethoxylated (6) trimethylolpropane triacrylate; SR502—ethoxylated (9) trimethylolpropane triacrylate; SR415—ethoxylated (20) trimethylolpropane triacrylate; CD9021—highly propoxylated (5.5) glyceryl triacrylate; SR351LV —low viscosity trimethylolpropane triacrylate; SR444—pentaerythritol triacrylate; SR9020—propoxylated (3) glyceryl triacrylate; SR9020HP —propoxylated (3) glyceryl triacrylate; SR492—propoxylated (3) trimethylolpropane triacrylate; CD501—propoxylated (6) trimethylolpropane triacrylate; SR351—trimethylolpropane triacrylate; SR350—trimethylolpropane trimethacrylate ; SR368—tris (2-hydroxy ethyl) isocyanurate triacrylate; SR368D —tris (2-hydroxy ethyl) isocyanurate triacrylate; SR355—ditrimethylolpropane tetraacrylate; SR399—dipentaerythritol pentaacrylate; Kayarad DPHA—dipentaerythritol pentaacrylate; SR494—ethoxylated (4) pentaerythritol tetraacrylate; SR399LV—low viscosity dipentaerythritol pentaacrylate ; SR9041—pentaacrylate ester; SR295—pentaerythritol tetraacrylate; kayarad DPCA-20—caprolactone modified dipentaerythritol hexaacrylate , and Kayarad DPCA60—caprolactone modified dipentaerythritol hexaacrylate.

Such acrylates with greater than two acrylate groups may be present in the radiation curable coating compositions of the present invention, prior to cure, in amounts from 1 to 50 wt. %, relative to the total weight of the coating composition excluding solvent, for example from 2 to 30 wt. %, or from 3 to 10 wt. %, such as 3 to 8 wt. %.

Reactive Nanoparticles

Examples of reactive nanoparticles that may be used in the radiation curable coating composition of the present invention include those derived from or including a metal oxide or metalloid oxide nanoparticles, for instance, oxides of silicon, aluminum, zirconium, titanium, zinc, germanium, indium, tin, antimony, and cerium. These nanoparticles may include a single metal oxide or metalloid oxide, and/or a mixture and/or a combination of different or more than one metal oxides and/or metalloid oxides.

These nanoparticles additionally include at least one reactive group (see discussion below), for instance a polymerizable group.

The reactive nanoparticles may be used, for instance, in the form of a powder or in the form of a water or solvent dispersion (sol). When the reactive nanoparticles are in the form of a dispersion, an organic solvent is preferable as a dispersion medium from the viewpoint of mutual solubility with other components and dispersibility. Use of a solvent dispersion of the reactive nanoparticles is particularly desirable in the application in which excellent transparency of cured products is required. Examples of organic solvents that may be useful as a solvent for the reactive nanoparticles include alcohols such as for example methanol, ethanol, isopropanol, butanol, and octanol; ketones such as acetone, methyl ethyl ketone, methyl isobutyl ketone, and cyclohexanone; esters such as for example ethyl acetate, butyl acetate, ethyl lactate, and γ-butyrolactone, propylene glycol monomethyl ether acetate, and propylene glycol monoethyl ether acetate; ethers such as for example ethylene glycol monomethyl ether and diethylene glycol monobutyl ether; aromatic hydrocarbons such as for example benzene, toluene, and xylene; and amides such as for example dimethylformamide, dimethylacetamide, and N-methylpyrrolidone.

In one embodiment, the nanoparticles useful for forming the reactive nanoparticle include colloidal silicon oxide nanoparticles. Such silica nanoparticles are available, for instance, under the trade names Methanol Silica Sol, EPA-ST, MEK-ST, NBA-ST, XBA-ST, DMAC-ST, ST-UP, ST-OUP, ST-20, ST-40, ST-C, ST-N, ST-O, ST-50, ST-OL, etc. manufactured by Nissan Chemical Industries, Ltd. Examples of powdery silica include products available under the trade names AEROSIL 130, AEROSIL 300, AEROSIL 380, AEROSIL TT600, and AEROSIL OX50 (manufactured by Japan Aerosil Co., Ltd.), Sildex H31, H32, H51, H52, H121, H122 (manufactured by Asahi Glass Co., Ltd.), E220A, E220 (manufactured by Nippon Silica Industrial Co., Ltd.), SYLYSIA470 (manufactured by Fuji Silycia Chemical Co., Ltd.) and SG Flake (manufactured by Nippon Sheet Glass Co., Ltd.).

Other useful nanoparticles that may be employed to form the reactive nanoparticles useful in radiation curable coating compositions of the present invention include aluminum oxide. Examples of commercially available dispersions of aluminium oxide nanoparticles in aqueous dispersions include Alumina Sol-100,-200,-520 (trade names, manufactured by Nissan Chemical Industries, Ltd.); isopropanol dispersions of alumina include AS-1501 (trade name, manufactured by Sumitomo Osaka Cement Co., Ltd.); and toluene dispersion of alumina include AS-150T (trade name, manufactured by Sumitomo Osaka Cement Co., Ltd.). An example of a toluene dispersion of zirconia useful in forming reactive nanoparticles that may be employed in the radiation curable coating compositions of the present invention include HXU-110JC (trade name, manufactured by Sumitomo Osaka Cement Co., Ltd.). Other nanoparticles that may be used to form reactive nanoparticles for use in the radiation curable composition of the present invention include, for example, an aqueous dispersion product of zinc antimonate powder, Celnax (commercially available from Nissan Chemical Industries, Ltd.), examples of powders and solvent dispersion products of alumina, titanium oxide, tin oxide, indium oxide, zinc oxide are available under the name, Nano Tek (commercially available from CI Kasei Co., Ltd., an aqueous dispersion sol of antimony dope-tin oxide, SN-100D (commercially available from Ishihara Sangyo Kaisha, Ltd.), an aqueous dispersion of cerium oxide, Needral (commercially available from Taki Chemical Co., Ltd.).

The shape of metal oxide or metalloid oxide nanoparticles (A) may be of a shape suitable for the desired application including spherical, non-spherical, hollow, porous, rod-like, plate-like, fibrous, amorphous and/or combinations of these. For example, the nanoparticles may be rod-like and hollow, or plate-like and porous, etc.

Examples of nanoparticles that may be employed to form the reactive nanoparticles that may be used in the radiation curable coating compositions of the present application include, for example, those having a plurality (for instance at least 60%, at least 75%, at least 90%, at least 94%, at least 96%, or at least 98%) of nanoparticles has a size below 900 nm, e.g. below 750 nm, below 600 nm, below 500 nm, below 300 nm, or below 150 nm, below 100 nm, or even below 75 nm and a size of at least 0.1 nm, e.g. at least 1 nm, at least 5 nm, at least 10 nm, or at least 20 nm. Processes for determining the particle size include, e.g., BET adsorption, optical or scanning electron microscopy, or atomic force microscopy (AFM) imaging.

Useful reactive particles for use in the radiation curable coating compostions of the present invention may include those formed from nanoparticles having an average size of nanoparticles below 900 nm, e.g. below 750 nm, below 600 nm, below 500 nm, below 300 nm, below 150 nm, below 100 nm, or even below 75 nm and above at least 0.1 nm, e.g. at least 1 nm, at least 5 nm, at least 10 nm, or at least 20 nm.

Examples of reactive groups on the nanoparticles that may be used in the radiation curable coating compositions of the present invention include, for example, organic and/or inorganic-organic components comprising a reactive group such as ethylenically unsaturated groups (including (meth)acrylate and/or vinyl ether groups).

Examples of reactive groups that may be grafted to, reacted with, or otherwise attached to the nanoparticles to form a reactive nanoparticle useful in the radiation curable coating composition of the present invention include:
(a) one or more groups represented by the following formula (1):
   —X—C(═Y)—NH— (1)
wherein X represents NH, O (oxygen atom), or S (sulfur atom), and Y represents O or S.The group represented by the formula (1) is, for instance, a urethane bond [—O—C(═O)—NH—], —O—C(═S)—NH—, or a thiourethane bond [—S—C(═O)—NH—],
(b) a silanol group or a group which forms a silanol group by hydrolysis, (c) alkoxysilane components which include a urethane bond [—O—C(═O)NH—] and/or a thiourethane bond [—S—C(═O)NH—] and at least two polymerizable unsaturated groups in the molecule,
(d) a triacrylate urethane silane component which is the reaction product of trimethoxy silane, isophorone diisocyanate, pentaerythritol tri(meth)acrylate;
(e) a component represented by the following general structural formula (2): 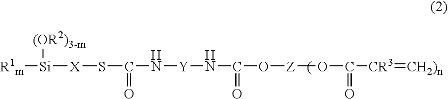
wherein R¹ represents a methyl group, R² represents an alkyl group having 1-6 carbon atoms, R³ represents a hydrogen atom or a methyl group, m represents either 0, 1, or 2, n represents an integer of 1-5, X represents a divalent alkylene group having 1-6 carbon atoms, Y represents a linear, cyclic, or branched divalent hydrocarbon group having 3-14 carbon atoms, Z represents a linear, cyclic, or branched divalent hydrocarbon group having 2-14 carbon atoms, and Z may include an ether bond; and
(f) a component represented by the following structural Formula I:

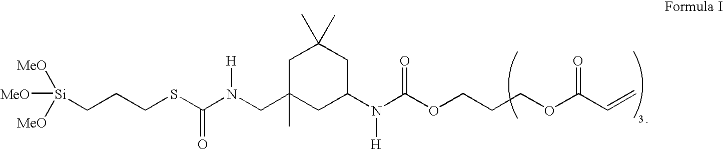

The component shown by the formula (2) may be prepared, for instance, by reacting a mercaptoalkoxysilane, a diisocyanate, and a hydroxyl group-containing polyfunctional (meth)acrylate.

Examples of hydroxyl group-containing polyfunctional (meth)acrylates include trimethylolpropane di(meth)acrylate, tris(2-hydroxyethyl)isocyanurate di(meth)acrylate, pentaerythritol tri(meth)acrylate, dipentaerythritol penta(meth)acrylate, and the like. Of these, tris(2-hydroxyethyl)isocyanurate di(meth)acrylate, pentaerythritol tri(meth)acrylate, and dipentaerythritol penta(meth)acrylate are preferable. These compounds form at least two polymerizable unsaturated groups in the compound shown by the formula (2).

The mercaptoalkoxysilane, diisocyanate, and hydroxyl group-containing polyfunctional (meth)acrylate may be used either individually or in combination of two or more.

In the preparation of the component shown by the formula (2), the mercaptoalkoxysilane, diisocyanate, and hydroxyl group-containing polyfunctional (meth)acrylate are used so that the molar ratio of the diisocyanate to the mercaptoalkoxysilane is preferably 0.8:1 to 1.5:1, and still more preferably 1.0-1.2. If the molar ratio is less than 0.8, storage stability of the composition may be decreased. If the molar ratio exceeds 1.5, dispersibility may be decreased.

It is preferable to prepare the component shown by the formula (2) in dry air in order to prevent anaerobic polymerization of the acrylic group and hydrolysis of the alkoxysilane. The reaction temperature is preferably 0-100° C., and still more preferably 20-80° C.

In the preparation of the component shown by the formula (2), a conventional catalyst may be used in the urethane formation reaction in order to reduce the preparation time. As the catalyst, dibutyltin dilaurate, dioctyltin dilaurate, dibutyltin di(2-ethylhexanoate), and octyltin triacetate can be given. In one embodiment, the catalyst is added in an amount of 0.01-1 wt % for the total amount of the catalyst and the diisocyanate.

A heat polymerization inhibitor may be added in the preparation in order to prevent heat polymerization of the compound shown by the formula (2). As examples of heat polymerization inhibitors, p-methoxyphenol, hydroquinone, and the like can be given. The heat polymerization inhibitor is added in an amount of preferably 0.01-1 wt % for the total amount of the heat polymerization inhibitor and the hydroxyl group-containing polyfunctional (meth)acrylate.

The component shown by the formula (2) may be prepared in a solvent. As the solvent, any solvent which does not react with mercaptoalkoxysilane, diisocyanate, and hydroxyl group-containing polyfunctional (meth)acrylate, and has a boiling point of 200° C. or less may be appropriately selected.

Specific examples of such solvents include ketones such as methyl ethyl ketone, methyl isobutyl ketone, and cyclohexanone, esters such as ethyl acetate, butyl acetate, and amyl acetate, hydrocarbons such as toluene and xylene, and the like.

Specific examples of alkoxysilane components include components having an unsaturated double bond in the molecule such as γ-methacryloxypropyltrimethoxysilane, γ-acryloxypropyltrimethoxysilane, and vinyltrimethoxysilane; components having an epoxy group in the molecule such as γ-glycidoxypropyltriethoxysilane and γ-glycidoxypropyltrimethoxysilane; compounds having an amino group in the molecule such as γ-aminopropyltriethoxysilane and γ-aminopropyltrimethoxysilane; components having a mercapto group in the molecule such as γ-mercaptopropyltrimethoxysilane and γ-mercaptopropyltriethoxysilane; alkylsilanes such as methyltrimethoxysilane, methyltriethoxysilane, and phenyltrimethoxysilane; and the like. Of these, γ-mercaptopropyltrimethoxysilane, γ-glycidoxypropyltrimethoxysilane, methyltrimethoxysilane, methyltriethoxysilane, and phenyltrimethoxysilane are preferable from the viewpoint of dispersion stability of the surface-treated oxide particles.

The reactive groups on the nanoparticles may also be a group that is polymerizable in combination with other groups. Examples of such combinations of groups include, for instance, carboxylic acids and/or carboxylic anhydrides combined with epoxies, acids combined with hydroxy compounds, especially 2-hydroxyalkylamides, amines combined with isocyanates, for example blocked isocyanate, uretdion or carbodiimide, epoxies combined with amines or with dicyandiamides, hydrazinamides combined with isocyanates, hydroxy compounds combined with isocyanates, for example blocked isocyanate, uretdion or carbodiimide, hydroxy compounds combined with anhydrides, hydroxy compounds combined with (etherified) methylolamide (“amino-resins”), thiols combined with isocyanates, thiols combined with acrylates (optionally radical initiated), acetoacetate combined with acrylates, and when cationic crosslinking is used, epoxy compounds with epoxy or hydroxy compounds. Thus, an example of a nanoparticle according to the present invention may have an amine group as reactive group and, in addition, an additional isocyanate group as reactive group, to form a combination of polymerizable groups.

Additional examples of reactive groups that may be used to form reactive nanoparticles include moisture curable isocyanates, moisture curable mixtures of alkoxy/acyloxy-silanes, alkoxy titanates, alkoxy zirconates, or urea-, urea/melamine-, melamine-formaldehyde or phenol-formaldehyde (resol, novolac types), or radical curable (peroxide-or photo-initiated) ethylenically unsaturated mono-and polyfunctional monomers and polymers, e.g. acrylates, methacrylates, maleate/vinyl ether), or radical curable (peroxide-or photo-initiated) unsaturated e.g. maleic or fumaric, polyesters in styrene and/or in methacrylates.

Examples of methods to prepare reactive nanoparticles of the present invention include those set forth in U.S. Pat. No. 6,160,067 to Eriyama et al. and WO 00/4766, which are both hereby incorporated in their entirety by reference. In addition, crosslinkable reactive nanoparticles may be produced by mixing a silanol group-forming component and a metal or metalloid oxide nanoparticle, and heating the mixture while stirring, preferably in the presence of water, to efficiently bind the silanol group-forming site possessed by an organic component and the metal oxide or metalloid oxide nanoparticle.

In addition, a dehydrating agent may be used to promote the reaction used to synthesize the formation of the reactive nanoparticles. Examples of dehydrating agents include inorganic compounds such as zeolites, anhydrous silica, and anhydrous alumina, as well as organic compounds such as methyl orthoformate, ethyl orthoformate, tetraethoxymethane, and tetrabutoxymethane can be used.

Also, methods for preparing reactive nanoparticles and reactive nanoparticles having at least one covalent fluorine bond are presented in the “Examples” section infra.

Reactive nanoparticles may comprise, in addition to one or more components having a reactive group, also one or more organic components not having a reactive group.

Components Comprising at Least One Covalent Fluorine Bond

1. Fluorinated Nanoparticles

Components of the present invention having at least one covalent fluorine bond may comprise at least one nanoparticle comprising such a bond (“fluorinated nanoparticles”). Such nanoparticles may, for example, be Reactive Nanoparticles that further comprise moieties containing a covalent fluorine bond, such as a carbon-fluorine bond (“fluorinated reactive nanoparticles”). These fluorine containing moieties may additionally include a reactive group.

For example, the Fluorinated Nanoparticles may comprise a trimethoxy silane species with a fluoroalkyl molecular component, such as, perfluorohexyl ethyl trimethoxysilane, perfluorooctyl ethyl trimethoxysilane, tridecafluoro-1,1,2,2-tetrahydrooctyl triethoxy silane, heptadecafluoro-1,1,2,2,tetra hydrodecyl triethoxy silane, or perfluorodecyl ethyl trimethoxysilane.

The fluorinated nanoparticles and fluorinated reactive nanoparticles may also comprise organic radicals containing one or more carbon-fluorine bonds. Examples of such radicals include difluoromethyl, trifluoromethyl, difluoroethyl, trifluoroethyl, tetrafluoroethyl, pentafluoroethyl, difluoropropyl, trifluoropropyl, tetrafluoropropyl, pentafluoropropyl, hexafluoropropyl, heptafluoropropyl, difluorobutyl, trifluorobutyl, tetrafluorobutyl, pentafluorobutyl, hexafluorobutyl, heptafluorobutyl, octafluorobutyl, difluoropentyl, trifluoropentyl, tetrafluoropentyl, pentafluoropentyl, hexafluoropentyl, heptafluoropentyl, octafluoropentyl, similarly perfluoro derivatives of C₁-C₃₀ branched or linear alkanes or alcohols and 1,1,2,2-tetrahydro fluoro derivatives of C₁-C₃₀ branched or linear alkanes or alcohols as well as partially ethoxylated or propoxylated versions of the aforementioned fluorinated alkanes/alcohols or 1,1,2,2-tetrahydro fluoro alkanes/alcohols. In one embodiment, the fluorinated nanoparticles or fluorinated reactive nanoparticles include a fluoroalkyl groups.

The present invention may use both reactive nanoparticles and fluorinated nanoparticles together, if desired. For example, weight ratios of reactive nanoparticles to fluorinated nanoparticles may be from 1:10 to 20:1, for instance 1:9 to 9:1, 1:1 to 15:1, 3:1 to 10:1, 3:1 to about 9:1, or 6:1 to about 8:1. Similarly, the present invention may also use both reactive nanoparticles and fluorinated reactive nanoparticles. For example, the weight ratio of reactive nanoparticles to fluorinated reactive nanoparticles may be from 1:10 to 20:1, for instance 1:9 to 9:1, 1:1 to 15:1, 3:1 to 10:1, 3:1 to about 9:1, or 6:1 to about 8:1.

2. Fluorinated Acrylate Component

The component having at least one covalent fluorine bond may also be a fluorinated organic compound containing at least one carbon-fluorine bond and at least one acrylate group. Such compounds may, for example, be monomeric, such as a fluorinated acrylate or fluorinated methacrylate or the like, or these compounds may be polymeric or oligomeric.

Suitable fluorinated oligomers include, for example, a fluorinated urethane oligomer comprising one or more ethylenically unsaturated groups and one or more urethane groups. Such fluorinated urethane oligomers may be the reaction product of a fluorinated polyol, a polyisocyanate and a reactive monomer containing ethylenic unsaturation. The reactive monomer may contain, e.g., (meth)acrylate, vinyl ether, maleate, fumarate or other ethylenically unsaturated group in its structure.

In one embodiment, the fluorinated urethane oligomer has a molecular weight in the range of about 700 to about 10,000 g/mol, for instance about 1000 to about 5000 g/mol.

The fluorinated polyols that may be used in the preparation of the fluorinated urethane oligomer include, e.g., fluorinated polymethylene oxide, polyethylene oxide, polypropylene oxide, polytetramethylene oxide or copolymers thereof. In one embodiment, the fluorinated polyols are endcapped with ethylene oxide. Suitable fluorinated polyols include, for instance, the Fluorolink fluids series of products (Fluorolink L, C, D, B, E, B1, T, L10, A10, D10, S10, C10, E10, T10, or F10) or Fomblin Z-Dol TX series of products, marketed by Solvay-Solexis Inc. These polyols are fluorinated poly(ethylene oxide-methylene oxide) copolymers endcapped with ethylene oxide. Other fluorinated polyols that may be suitable include acrylic oligomers or telechelomers with pendant or main-chain fluorinated functionality such as acrylic copolymers of hexafluoropropene and hydroxybutyl acrylate, or acrylic copolymers of trifluoroethyl (meth)acrylate and hydroxybutyl acrylate. Other suitable fluorinated polyols include polyols such as L-12075 marketed by 3M corporation and the MPD series of polyols marketed by Dupont.

Polyisocyanates that may be used in the preparation of fluorinated urethane oligomers include a wide variety of organic polyisocyanates, alone or in admixture. The polyisocyanates may be reacted with the fluorinated polyols and ethylenically unsaturated isocyanate reactive compounds to form the ethylenically unsaturated urethane fluorinated component: Diisocyanates are among the preferred polyisocyanates. Representative diisocyanates include isophorone diisocyanate (IPDI), toluene diisocyanate (TDI), diphenylmethylene diisocyanate, hexamethylene diisocyanate, cyclohexylene diisocyanate, methylene dicyclohexane diisocyanate, 2,2,4-trimethyl hexamethylene diisocyanate, m-phenylene diisocyanate, 4-chloro-1,3-phenylene diisocyanate, 4,4′-biphenylene diisocyante, 1,5-naphthylene diisocyanate, 1,4-tetramethylene diisocyanate 1,6-hexamethylene diisocyanate, 1,10-decamethylene diisocyanate, 1,4-cyclohexylene diisocyanate, and polyalkyloxide and polyester glycol diisocyanates such as polytetramethylene ether glycol terminated with TDI and polyethylene adipate terminated with TDI, respectively.

The fluorinated polyol and polyisocynate may be combined in a weight ratio of about 1.5:1 to about 7.5:1 fluorinated polyol to polyisocyanate. The fluorinated polyol and polyisocyanate may be reacted in the presence of a catalyst to facilitate the reaction. Catalysts for the urethane reaction, such as dibutyltin dilaurate and the like, are suitable for this purpose.

The isocyanate-terminated prepolymers may be endcapped by reaction with an isocyanate reactive functional monomer containing an ethylenically unsaturated functional group. The ethylenically unsaturated functional groups are preferably acrylates, vinyl ethers, maleates, fumarates or other similar compounds.

Suitable monomers that are useful to endcap the isocyanate terminated prepolymers with the desired (meth)acrylate functional groups include hydroxy functional acrylates such as 2-hydroxy ethyl acrylate, pentaerythritol triacrylate, 2-hydroxy propyl acrylate and the like.

Suitable monomers which are useful to endcap the isocyanate terminated prepolymers with the desired vinyl ether functional groups include 4-hydroxybutyl vinyl ether, triethylene glycol monovinyl ether and 1,4-cyclohexane dimethylol monovinyl ether. Suitable monomers which are useful to endcap the prepolymers with the desired maleate functional group, include maleic acid and hydroxy functional maleates.

A sufficient amount of isocyanate reactive functionality may be present in the monomer containing acrylate, vinyl ether, maleate or other ethylenically unsaturated groups to react with any residual isocyanate functionality remaining in the prepolymer and endcap the prepolymer with the desired functional group. The term “endcap” means that a functional group caps each of the two ends of the prepolymer.

The isocyanate reactive ethylenically unsaturated monomer may then be directly reacted with the reaction product of the fluorinated polyol and the isocyanate. Such a reaction may take place in the presence of an antioxidant such as BHT and the like.

The ethylenically unsaturated urethane fluorinated component may have a viscosity, at 23° C., of at least 2500 centipoises (“cps”), e.g., at least 5000 cps, at least 7500 cps, at least 10,000 cps, at least 25,000 cps, or at least 50,000 cps. The viscosity of the ethylenically unsaturated urethane fluorinated component may be less than 10,000,000 cps, for instance less than 5,000,000 cps, or less than 1,000,000 cps.

The percentage of ethylenically unsaturated urethane fluorinated components, relative to the combined weight of all reactive particles and ethylenically unsaturated urethane fluorinated components, may be at least 0.75 wt %, e.g., at least 1 wt %, at least 2 wt %, at least 3 wt %, or at least 5 wt %. The percentage of ethylenically unsaturated urethane fluorinated components, relative to the combined weight of all reactive particles and ethylenically unsaturated urethane fluorinated components, may be less than 35 wt %, e.g., less than 25 wt %, or less than 15 wt %, or less than 10 wt %, or less than 8 wt %.

Photoinitiators

Photoinitiators useful in the present invention include, e.g., hydroxy- or alkoxy-functional acetophenone derivatives, hydroxyalkyl phenyl ketones, and/or benzoyl diaryl phosphine oxides. Examples of photoinitiators include Irgacure 651 (benzildimethyl ketal or 2,2-dimethoxy-1,2-diphenylethanone, Ciba-Geigy), Irgacure 184 (1-hydroxy-cyclohexyl-phenyl ketone as the active component, Ciba-Geigy), Darocur 1173 (2-hydroxy-2-methyl-1-phenylpropan-1-one as the active component, Ciba-Geigy), Irgacure 907 (2-methyl-1-[4-(methylthio)phenyl]-2-morpholino propan-1-one, Ciba-Geigy), Irgacure 369 (2-benzyl-2-dimethylamino-1-(4-morpholinophenyl)-butan-1-one as the active component, Ciba-Geigy), Esacure KIP 150 (poly {2-hydroxy-2-methyl-1-[4-(1-methylvinyl)phenyl]propan-1-one}, Fratelli Lamberti), Esacure KIP 100 F (blend of poly {2-hydroxy-2-methyl-1-[4-(1methylvinyl)phenyl]propan-1-one } and 2-hydroxy-2-methyl-1-phenyl-propan-1-one, Fratelli Lamberti), Esacure KTO 46 (blend of poly {2-hydroxy-2-methyl-1-[4-(1-methylvinyl)phenyl]propan-1-one}, 2,4,6-trimethylbenzoyldiphenylphosphine oxide and methylbenzophenone derivatives, Fratelli Lamberti), Lucirin TPO (2,4,6-trimethylbenzoyl diphenyl phosphine oxide, BASF), Irgacure 819 (bis (2,4,6-trimethylbenzoyl)-phenyl-phosphine-oxide, Ciba-Geigy), Irgacure 1700 (25:75% blend of bis (2,6-dimethoxybenzoyl)2,4,4-trimethylpentyl phosphine oxide and 2-hydroxy-2-methyl-1-phenyl-propan-1-one, Ciba-Geigy), Irgacure OXEO1 ((1,2-octanedione, 1-[4-(phenylthio) phenyl]-,2-(O-benzoyloxime), Ciba-Geigy), Irgacure 379 (2-dimethylamino-2-(4-methyl-benzyl)-1-(4-morpholin-4yl-phenyl)-butan-1-one, Ciba-Geigy) Uvatone 8302 (Upjohn); and alpha, alpha-dialkoxyacetophenone derivatives such as DEAP and UVATONE 8301 from Upjohn, and the like.

Monomers having two different types of ethylenic unsaturation, i.e., the vinyl ether group and another ethylenically unsaturated group, may copolymerize rapidly in the presence of these photoinitiators to provide a rapid photocure and also interact rapidly upon exposure to different types of radiation energy such as electron beam when no polymerization initiator is present.

One or more photoinitiators may be present in the radiation curable compositions of the present invention in, for example, at least 6.0 wt %, relative to the total weight of the composition excluding solvent, for example, in at least 6.25, 6.5, 6.75, 7.0, 7.25, 7.5, 7.75, 8.0, 8.25, 8.5, 8.75, 9.0, 9.25, 9.5, 9.75, 10, 10.5, 11, 11.5, 12, 12.5, 13, 13.5, 14, or at least 14.5 wt. %.

Cure Enhancing Agents

The low refractive index radiation curable coating compositions of the present invention may further comprise at least one cure enhancing agent. Such agents may promote the rate at which the curable composition may cure, or produce a more complete cure, or a harder final product. Examples of such cure enhancing agents include diamines, phosphines, phosphites and thiols. An example of a diamine is N,N,N-triethyl ethylene diamine. Examples of suitable phosphines and phosphites include substituted or unsubstituted, linear or branched C₁-C₂₀ alkyl or alkenyl, or substituted or unsubstituted C₆-C₂₀ aryl phosphines or phosphites, for example, trialkyl or triaryl phosphines or phosphites, for example triphenyl phopshine or triphenyl phosphite. Examples of suitable thiols include, for example, trimethylolpropane tris(3-mercaptopropionate).

Polymeric Surfactants

The low refractive index radiation curable coating composition of the present invention may also comprise a polymeric surfactant. Such polymeric surfactants may include those surfactants with a glass transition temperature greater than 70° C., for example greater than 100° C., or greater than 120° C. At least one polymeric surfactant may be selected from cellulose acetate butyrate; a polyacrylate made from the polymerization of methyl methacrylate, ethyl acrylate and methacrylic acid; or a polyacrylate made from the polymerization of methyl methacrylate and methacrylic acid. An example of a polyacrylate made from the polymerization of methyl methacrylate, ethyl acrylate and methacrylic acid is Elvacite 2669, and an example of a polyacrylate made from the polymerization of methyl methacrylate and methacrylic acid is Elvacite 2008. The polymeric surfactant may be used alone or added as a solution of polymeric surfactant in a solvent or monomer, such as acrylic acid.

Diluent Monomers

The radiation curable coating compositions may also comprise a diluent monomer, for example, to reduce the viscosity of the coating compositions. Examples of diluent monomers include polymerizable vinyl monomers such as polymerizable monofunctional vinyl monomers containing one polymerizable vinyl group in the molecule and polymerizable polyfunctional vinyl monomers containing two or more polymerizable vinyl groups in the molecule.

Examples of monofunctional diluent monomers include, e.g., monofunctional vinyl monomers such as N-vinyl pyrrolidone, N-vinyl caprolactam, vinyl pyridine; (meth)acrylates containing an alicyclic structure such as isobornyl (meth)acrylate or 4-butylcyclohexyl (meth)acrylate; 2-hydroxyethyl (meth)acrylate, 2-hydroxypropyl (meth)acrylate, 2-hydroxybutyl (meth)acrylate, methyl (meth)acrylate, ethyl (meth)acrylate, propyl (meth)acrylate, isopropyl (meth)acrylate, butyl (meth)acrylate, amyl (meth)acrylate, isobutyl (meth)acrylate, t-butyl (meth)acrylate, pentyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, decyl (meth)acrylate, isodecyl (meth)acrylate, dodecyl (meth)acrylate, lauryl (meth)acrylate, stearyl (meth)acrylate.

Examples of polyfunctional diluent monomers include, e.g., trimethylolpropane tri(meth)acrylate, pentaerythritol tri(meth)acrylate, ethylene glycol di(meth)acrylate, tetraethylene glycol di(meth)acrylate, polyethylene glycol di(meth)acrylate, 1,4-butanediol di(meth)acrylate, 1,6-hexanediol di(meth)acrylate, neopentyl glycol di(meth)acrylate, trimethylolpropanetrioxyethyl (meth)acrylate, tris(2-hydroxyethyl)isocyanurate tri(meth)acrylate, tris(2-hydroxyethyl)isocyanurate di(meth)acrylate, and bis(hydroxymethyl)tricyclodecane di(meth)acrylate.

Diluent monomers may also be halogenated, for instance, fluorinated. Examples of fluorinated diluent monomers include, fluorinated acrylate monomers, for instance 2,2,3,3-tetrafluoropropyl acrylate, 1H,1H,5H-octafluoropentyl acrylate, or 1H,1H,2H,2H-heptadecafluorodecyl acrylate.

The radiation curable coating compositions may also comprise, relative to the combined weight of all reactive particles and ethylenically unsaturated urethane fluorinated components, 0-20 wt % of one or more diluents, e.g., 0.1-10 wt %, 0.25-5 wt %, or 0.5-2.5 wt %.

Additives

Various additives such as antioxidants, UV absorbers, light stabilizers, adhesion promoters, coating surface improvers, heat polymerization inhibitors, leveling agents, surfactants, colorants, preservatives, plasticizers, lubricants, solvents, fillers, aging preventives, and wettability improvers may be included in the present coating compositions. Examples of antioxidants include Irganox 1010, 1035, 1076, 1222 (manufactured by Ciba Specialty Chemicals Co., Ltd.), Antigene P, 3C, FR, Sumilizer GA-80 (manufactured by Sumitomo Chemical Industries Co., Ltd.), and the like; examples of UV absorbers include Tinuvin P, 234, 320, 326, 327, 328, 329, 213 (manufactured by Ciba Specialty Chemicals Co., Ltd.), Seesorb 102, 103, 110, 501, 202, 712, 704 (manufactured by Sypro Chemical Co., Ltd.), and the like; examples of light stabilizers include Tinuvin 292, 144, 622LD (manufactured by Ciba Specialty Chemicals Co., Ltd.), Sanol LS770 (manufactured by Sankyo Co., Ltd.), Sumisorb TM-061 (manufactured by Sumitomo Chemical Industries Co., Ltd.), and the like; examples of silane coupling agents as adhesion promoters γ-mercaptopropylmethylmonomethoxysilane, γ-mercaptopropylmethyldimethoxysilane, γ-mercaptopropyltrimethoxysilane, γ-mercaptopropylmonoethoxysilane, γ-mercaptopropyldiethoxysilane, γ-mercaptopropyltriethoxysilane, β-mercaptoethylmonoethoxysilane, β-mercaptoethyltriethoxysilane, β-mercaptoethyltriethoxysilane, N-(2-aminoethyl)-3-aminopropylmethyldimethoxysilane, N-(2-aminoethyl)-3-aminopropyltrimethoxysilane, γ-aminopropyltriethoxysilane, γ-glycidoxylpropyltrimethoxysilane, γ-glycidoxylpropylmethyldimethoxysilane, 2-(3,4-epoxycyclohexyl) ethyltrimethoxysilane, γ-chloropropylmethyldimethoxysilane, γ-chloropropyltrimethoxysilane, and γ-methacryloyloxypropyltrimethoxysilane. Examples of commercially available products of these compounds include SILAACE S310, S311, S320, S321, S330, S510, S520, S530, S610, S620, S710, S810 (manufactured by Chisso Corp.), Silquest A-174NT (manufactured by OSI Specialties—Crompton Corp.). SH6062, AY43-062, SH6020, SZ6023, SZ6030, SH6040, SH6076, SZ6083 (manufactured by Toray-Dow Corning Silicone Co., Ltd.), KBM403, KBM503, KBM602, KBM603, KBM803, KBE903 (manufactured by Shin-Etsu Silicone Co., Ltd.), and the like. Also acidic adhesion promoters such as acrylic acid may be used. Phosphate esters such as Eb168 or Eb170 from UCB are feasible adhesion promoters; Examples of coating surface improvers include silicone additives such as dimethylsiloxane polyether and commercially available products such as DC-57, DC-190 (manufactured by Dow-Corning), SH-28PA, SH-29PA, SH-30PA, SH-190 (manufactured by Toray-Dow Coming Silicone Co., Ltd.), KF351, KF352, KF353, KF354 (manufactured by Shin-Etsu Chemical Co., Ltd.), and L-700, L-7002, L-7500, FK-024-90 (manufactured by Nippon Unicar Co., Ltd.).

The radiation curable coating compositions may also comprise, relative to the total weight of fluorinated acrylate components, about 0.01 to about 10 weight percent of adhesion promoter. In addition, the radiation curable coating compositions of the present invention may also comprise, relative to the total weight of fluorinated acrylate components, about 0.01 to about 5 weight percent based of antioxidant.

Physical Properties

The radiation curable coating composition of the invention, when cured in air, may provide a coating with low refractive index, for example, a cured coating with a refractive index of less than 1.55, for example, less than 1.50, or less than 1.48, or less than 1.46 or less than 1.44, for example, in the range of from about 1.35 to about 1.50, for instance, from about 1.40 to about 1.48, or from about 1.42 to about 1.46, for example, from about 1.432 to about 1.50.

The radiation curable coating compositions of the present invention may also have good surface hardness and abrasion resistance. These are characterized by pencil test for film hardness and abrasion test, the coating has a pencil hardness of greater than or equal to H, or at least 2H, or greater than 2H.

The low refractive index radiation curable coating composition may have, after curing in air, an ethanol rub value of greater than 3, for example, greater than 10 or greater than 25. The procedure for measuring the ethanol rub value is set forth in the Examples section.

The degree of cure of the composition can be indicated by the percentage of reacted acrylated unsaturation (% RAU). The test method of measuring % RAU is mentioned in the Example part of the description of invention. The radiation curable coating composition of the present invention, when cured in air, may have a % RAU of at least 40%, e.g. 45% to 98% or 55% to 70%, and/or a 95% Relative RAU Dose of equal to or less than 0.7 J/cm², for example, less than 0.5 J/cm , or less than 0.3 J/cm², or less than 0.2 J/cm², at thicknesses of less than 1 μm, for example, less than 0.8 μm, or less than 0.5 μm or less than 0.3 μm.

The specular reflectance of the radiation curable coating compositions of the present invention may be, for example, after curing less than 1.0, for example less than 0.5.

The total reflectance of the radiation curable coating composition of the present invention may be, for example, after curing in air less than 2.0, for example, less than 1.9 or less than 1.8.

The radiation curable coating composition of the present invention may have, after cure in air, a specular reflectance and/or total reflectance such that they provide a suitable anti-reflective effect as a coating atop the high refractive index coating in an anti-reflective coating system.

The compositions in the present invention may be used as a low reflective index layer for an antireflective display system. The antireflective display system may comprise a substrate, a hardcoat layer on the substrate, a high refractive index layer applied on the hardcoat layer, following by a low refractive index layer.

The present compositions may be used as coating compositions. For instance, the present compositions may be used to coat substrates. Suitable substrates to be coated include organic substrates. Organic substrates are preferably polymeric (“plastic”) substrates, such as substrates comprising polynorbornene, polyethyleneterephthalate, polymethylmethacrylate, polycarbonate, polyethersulphone, polyimide, fluorene polyester (e.g. a polymer consisting essentially of repeating interpolymerized units derived from 9,9-bis(4-hydroxyphenyl)fluorene and isophthalic acid, terephthalic acid or mixtures thereof), cellulose (e.g. triacetate cellulose), and/or polyethernaphthalene. Particularly preferred substrates include polynorbornene substrates, fluorene polyester substrates, triacetate cellulose substrates, and polyimide substrates.

Suitable substrates for display include organic substrates, e.g. plastic substrates such as substrates comprising polynorbornene, polyethyleneterephtalate, polymethylmethacrylate, polycarbonate, polyethersulphone, polyimide, cellulose, cellulose triacetate, fluorene polyester and/or polyethernaphtalene. Other examples of substrates include, e.g., inorganic substrates such as glass or ceramic substrates.

The substrates may be pre-treated prior to coating. For instance, the substrates may be subjected to corona or high energy treatment. The substrates may also be chemically treated, such as by emulsion application.

The substrate may also comprise functional groups such as hydroxy groups, carboxylic acid groups and/or trialkoxysilane groups such as trimethoxysilane. The presence of such functional groups may improve adhesion of the coating to the substrate.

The radiation curable coating compositions of the present invention may also be used as an optical fiber primary coating, an optical fiber secondary coating, a matrix coating, a bundling material, an ink coating, a photonic crystal fiber coating, an adhesive for optical disc, a hardcoat coating, or a lens coating.

In one embodiment, the present invention provides an article comprising a low refractive index coating obtained by curing a composition comprising:
a. an acrylate having greater than 2 acrylate groups;
b. at least one component having at least one covalent fluorine bond; and
c. one or more photoinitiators;
   wherein the total quantity of the photoinitiator in said composition is at least 6 wt. % relative to the total weight of the composition excluding solvent. Said article may further comprise a high refractive index layer, in a further embodiment, the article may further comprise a substrate, and a hardcoat layer, wherein said hardcoat lawyer is coated directly on said substrate and said high refractive index coating is on the hardcoat layer.

In another embodiment of the present invention, an antireflective coating system comprising
a high refractive index coating; and
a low refractive index coating comprising:
   an acrylate having greater than 2 acrylate groups;
at least one component having at least one covalent fluorine bond; and
one or more photoinitiators;
   wherein the total quantity of the photoinitiator in said composition is at least 6 wt. % relative to the total weight of the composition excluding solvent. In one embodiment, the said high refractive index coating has a refractive index of at least 1.58. In another embodiment, the low refractive index coating has a refractive index of less than 1.55.

The present invention also provides for a method of making a fast-curing, thin, low-refractive index coating composition comprising:
a. mixing:
b. an acrylate having greater than 2 acrylate groups;
c. at least one component having at least one covalent fluorine bond; and
d. one or more photoinitiators;
   wherein the total quantity of the photoinitiator in said composition is at least 6 wt. % relative to the total weight of the composition excluding solvent.

### EXAMPLES

The following examples are given as particular embodiments of the invention and to demonstrate the practice and advantages thereof. It is to be understood that the examples are given by way of illustration and are not intended to limit the specification or the claims that follow in any manner.

The following component names are used in the Examples and are understood to refer to the compounds or compositions noted.
a. SR-351—trimethylolpropane triacrylate, commercially available from Sartomer;
b. SR-399—dipentaerythritol pentaacrylate, commercially available from Sartomer;
c. Darocur 1173—2-hydroxy-2-methyl-1-phenylpropan-1-one, commercially available from Ciba;
d. Irgacure 907—2-methyl-1-[4-(methylthio)phenyl]-2-morpholino-propan-1-one, commercially available from Ciba;
e. Irgacure 819—bis(2,4,6-trimethylbenzoyl)-phenyl-phosphine-oxide, commercially available from Ciba;
f. Irgacure 369—2-benzyl-2-dimethylamino-1-(4-morpholinophenyl)-butan-1-one, commercially available from Ciba;
g. Irgacure 184—1-hydroxy-cyclohexyl-phenyl ketone, commercially available from Ciba;
h. Darocur 4265—a mixture of 50% acyl phosphine oxide and 50% 2-hydroxy-2-methyl-1-phenylpropan-1-one, commercially available from Ciba;
i. Irganox 1035—bis (3,5-di-tert-butyl-4-hydroxyhydrocinnamate), commercially available from Ciba;
j. BHT—3,5-di-tert-butyl-4-hydroxytoluene;
k. Fluorolink E—poly(ethylene oxide-methylene oxide) copolymers endcapped with ethylene oxide, commercially available from Solvay-Solexis;
l. Lucirin TPO—2,4,6-Trimethylbenzoyldiphenylphosphine oxide;
m. Triacrylate urethane silane is the reaction product of a mercaptoalkoxysilane, a diisocyanate, and a hydroxyl group-containing polyfunctional (meth)acrylate;
n. MT-ST—a nanosilica particle dispersion in methanol (30 wt % particles), commercially available from Nissan Chemical;
o. MEK-ST—a nanosilica particle preparation in methyl ethyl ketone (30 wt % particles), commercially available from Nissan Chemical;
p. CAB—cellulose acetate butyrate available from Eastman Chemical;
q. CAB/AA—a 20 wt. % solution of CAB in acrylic acid;
r. PET—polyethylene terephthalate
s. HQMME—hydroquinone mono-methylether; and
t. H-I-FluorolinkE-I-H—a fluorinated acrylate component from the reaction of 2-hydroxyethyl acrylate (8.18 wt. %), isophorone diisocyanate (15.70 wt. %), FluorolinkE (76.01 wt. %), BHT (0.07 wt. %) and dibutyltin dilaurate (0.04 wt. %); wherein “H” to 2-hydroxyethyl acrylate “I” refers to isophorone diisocyanate, and “FluorolinkE” (76.01 wt. %) refers to a resin of perfluorinated polyether diol that is ethoxylated with ethylene oxide.
   Preparation of a Fluorinated Acrylate Pre-Composition

A Fluorinated Acrylate Pre-Composition was prepared by mixing the ingredients specified in Table 1.

TABLE 1
Fluorinated Acrylate Pre-Composition

| Component | wt % |
|---|---|
| H-I-FluorolinkE-I-H | 80.7 |
| Lucirin TPO | 0.5 |
| Irgacure 184 | 1.5 |
| Irganox 1035 | 0.3 |
| Hexanediol diacrylate | 16.0 |
| Mercaptopropyl trimethoxy silane | 1.0 |

Preparation of a Fluorinated Reactive Nanoparticle Sol

The components and their relative amounts used to prepare a Fluorinated Reactive Nanoparticle Sol are shown in Table 2 below. Triacrylate urethane silane and HQMME were added to MT-ST. Approximately 1.7 wt. % of the MT-ST suspension was water. This mixture was refluxed with stirring for a minimum of three hours, at which time a fluorinated alkoxy silane compound, (tridecafluoro-1,1,2,2-tetrahydrooctyl)triethoxysilane, was added and the resultant mixture was again refluxed with stirring at 60° C. for at least one hour. Following this, an alkoxy silane compound, methyltrimethoxysilane, was added and the resultant mixture was stirred and refluxed at 60° C. for at least one hour. A dehydrating agent, trimethyl orthoformate, was added and the resultant mixture was stirred and refluxed at 60° C. for at least one hour.

TABLE 2
Fluorinated Reactive Nanoparticle Sol (34.7% Solids)

| Component | wt % |
|---|---|
| MT-ST | 81.14% |
| triacrylate urethane silane | 7.68% |
| HQMME | 0.14% |
| (Tridecafluoro-1,1,2,2-tetrahydrooctyl)triethoxysilane, | 2.28% |
| Methyltrimethoxysilane | 0.61% |
| Trimethyl orthoformate | 8.15% |
| Total | 100% |

Preparation of a Reactive Nanoparticle Sol

The components and their relative amounts used to prepare the Reactive Nanoparticle Sol are shown in Table 3 below. Triacrylate urethane silane and HQMME were to MEK-ST. A small amount of water was added to the MEK-ST suspension (1.7 wt. % relative to the total MEK-ST). The mixture was then refluxed with stirring for at least three hours at 60° C., at which point an alkoxy silane compound, methyltrimethoxysilane, was added and the resultant mixture refluxed and stirred at 60° C. for an additional one hour. A dehydrating agent, trimethyl orthoformate, was added and the resultant mixture was stirred and refluxed at 60° C. for at least one hour.

TABLE 3
Reactive Nanoparticle Sol (36.2% Solids)

| Component | Wt % |
|---|---|
| MEK-ST | 82.50% |
| triacrylate urethane silane | 7.84% |
| HQMME | 0.14% |
| Methyltrimethoxysilane | 1.23% |
| Trimethyl orthoformate | 8.29% |
| Total | 100% |

### Examples 1-4 and Comparative Examples A-D

The components and their relative amounts used to prepare the compositions of Examples 1-4 and Comparative Examples A-D are shown in Table 4 below.

TABLE 4

| | Cured in Air | | | | | | Cured in N2 | |
|---|---|---|---|---|---|---|---|---|
| Component | 1 | 2 | 3 | 4 | Comp A | Comp B | Comp C | Comp D |
| Fluorinated Acrylate | 2.28 | 2.53 | 2.87 | 2.87 | 3.51 | 3.46 | 3.51 | 3.46 |
| Pre-Composition | | | | | | | | |
| Fluorinated Reactive | — | 8.24 | — | — | 11.39 | 11.22 | 11.39 | 11.22 |
| Nanoparticle Sol | | | | | | | | |
| (34.7%) | | | | | | | | |
| Reactive Nanoparticle | 11.02 | 5.33 | 14.39 | 14.39 | 5.69 | 5.61 | 5.69 | 5.61 |
| Sol (36.2%) | | | | | | | | |
| Darocure 1173 | — | — | — | — | 0.48 | 0.47 | 0.48 | 0.47 |
| SR-399 | 1.88 | 0.38 | — | 0.96 | — | — | — | — |
| SR-351 | — | — | 0.96 | — | — | — | — | — |
| Irgacure 907 | 1.24 | 1.08 | 0.96 | 0.96 | — | 0.15 | — | 0.15 |
| Irgacure 184 | | 0.01 | — | — | — | — | — | — |
| CAB/AA | 0.5 | 0.43 | — | — | — | — | — | — |
| N,N,N,Triethyl | 0.12 | 0.11 | — | — | — | — | — | — |
| ethylene diamine | | | | | | | | |
| Methyl Ethyl Ketone | 82.96 | 81.89 | 80.82 | 80.82 | 78.83 | 79.09 | 78.83 | 79.09 |

Properties

| | | | | | | | | |
|---|---|---|---|---|---|---|---|---|
| Total Reflectance | 2 | 1.67-1.8 | — | — | Na | na | 1.42 | 1.52 |
| Specular reflectance | 0.71 | 0.52-0.69 | — | — | Na | na | 0.21 | 0.22 |
| Pencil hardness | 2H | H | 2H-3H | 2H-3H | <4B | <4B | F | 2H |
| Ethanol rub | >50 | 2-4 | — | — | 0-1 | 0-1 | 3-4 | 3-5 |
| 95% Relative RAU Dose | 0.20 | 0.17 | 0.19 | 0.28 | 2.20 | 0.73 | — | — |
| (J/cm2) | | | | | | | | |
| Refractive Index | 1.493 | 1.479 | 1.470 | 1.479 | — | — | — | — |

General Procedures and Test Methods
Preparation of Test Sample

PET substrates (0.007″ Mylar polyester drawdown sheets) were affixed to a 3 mm thick glass plate using masking tape. A UV-curable hardcoat (Desolite® 4D5-15, 50% solids in methyl ethyl ketone, DSM Desotech Inc.) was applied to the PET substrate using a standard #6 wire-wound coating application rod (available from BYK-Gardner) resulting in a wet film of approximately 13 microns in thickness. The wet film was then allowed to evaporate solvents for a period of 3 minutes at room temperature. The evaporated hardcoat was then subjected to a UV radiation dose of 1.0 j/cm² using a Fusion 300W H-lamp in an air atmosphere. The UV-dose was verified using an International Light model IL 390B Light Bug ultraviolet radiometer. Sample substrates were prepared from these cured films by cutting 3″×3″ squares using a razor blade and removed from the glass plate.

A high refractive-index coating layer (Desolite® KZ7987C, Japan Fine Coatings Ltd., having a cured film refractive index of 1.69, diluted to 5% solids in methyl ethyl ketone) was applied by spin coating onto the above described hardcoated 3″×3″ PET substrate resulting in a high refractive-index coating thickness of approximately 0.1-0.15 micron. The spin coating was prepared using a standard Headway Research model EC101DT spin coater, by depositing 1 ml of the liquid composition on a stationary 3″×3″ substrate mounted on the spin-coater chuck platform. The applied liquid/substrate was then spin coated at 7500 rpm at a spin acceleration rate of 3000 rpm/s for 12 seconds. The resultant thin wet film after spin-coating was allowed to further evaporate at room temperature for 60 seconds. The evaporated thin film was subjected to a UV-dose of 1.0 J/cm² utilizing a 300 W Fusion H-lamp in an air atmosphere. The UV-dose was verified using an International Light model IL 390B Light Bug ultraviolet radiometer.

Similarly, the experimental low refractive index coating compositions (inventive and comparative examples, were diluted to 4.6% solids in methyl ethyl ketone) were spin-coated on the 3″×3″ hardcoated/high refractive-index coated PET substrates by spin coating (as described above) and cured, resulting in a 3-layered coating structure “Test Sample” having the cured low refractive index experimental coating on the top surface.

Pencil Hardness Test Method (Scratch Hardness):

The pencil hardness of the subject coating was tested according to standard method ASTM D3363. The pencil was held firmly against the low refractive-index coated surface of the Test Sample at a 45° angle using a sled weighing 750 g, and pushed away from the operator in a 6.5 mm (¼ in.) stroke. The measurement was performed first with the hardest pencil and repeated moving down the scale of hardness pencils until a pencil that did not scratch the film was found (scratch hardness).

The pencil hardness of the film was measured in accordance with the ASTM pencil harness scale:

$$\frac{6 B \text{-} 5 B \text{-} 4 B \text{-} 3 B \text{-} 2 B \text{-} B \text{-} HB \text{-} F \text{-} H \text{-} 2 H \text{-} 3 H \text{-} 4 H \text{-} 5 H \text{-} 6 H}{\begin{matrix}Softer & Harder\end{matrix}}$$

wherein the difference between two adjacent leads shall be considered one unit of hardness.
Refractive Index Test Method

A glass microscope slide was coated with the experimental coating composition and cured by UV exposure after solvent evaporation using a radiation dose of 1.0 J/cm² from a Fusion 300 W H-lamp in an air atmosphere. 2 mm×2 mm squares were then cut into the cured film using a razor blade, and alternating squares were removed from the cured film. The slide was then placed under lOx microscope set up for collimated axial transmitted illumination, and fitted with objectives of up to at least 0.70 numerical aperture. Monochromatic illumination was achieved by placing narrow bandwidth interference filters in the path of the microscope's built-in illumination system to provide 589 nm wavelength light (sodium D-line). The cured film was then compared to standard liquids of known refractive index (Cargill Index of Refraction Liquids, Standard Group available from McCrone Microscopy Inc.). Using the bottle applicator rod, a small drop of the refractive index liquid was applied to the vacancy left by the removed squares of the cured film. As the microscope focus was adjusted so that the distance between the refractive index. If the coating had a higher refractive index than the known refractive index liquid, the Becke' line moved to the outline of the squares as the focus is moved “up”. The process was reiterated until the outline of the squares disappeared.

If the outline of the coating squares failed to disappear and two liquids adjacent to one another in the set were found which give opposite signs of Becke' line movement, the refractive index of the material then lies between the two values, most likely centered in the range.

Reflectivity Test Method

Total reflectance measurements were performed on Test Samples adapted to include a strip of one inch black vinyl tape. The Test Samples were mounted on an 8° sample holder using a Perkin Elmer Lambda 800/900 UV-Vis Spectrophotometer equipped with a 60 mm integrating sphere with a thermostat-regulated lead sulfide (PbS) detector and a 5 nm slit, operating at a scan speed of 250 nm/min. Diffuse reflectance was measured in a similar fashion without an 8° mounting. From these measurements, specular reflectance for the subject low refractive-index coating was determined by subtracting diffuse reflectance from the total reflectance.

Ethanol Rubs Test Method

A Q-tip (cotton applicator) was soaked in ethanol and any excess ethanol removed by squeezing. By applying medium pressure (manually) individual rubs with the wet Q-tip along a Test Sample are counted, until any defect was detected (e.g., removal of part of the coating).

95% Relative RAU Dose Test Method

A drop of the desired liquid coating was spin-coated on a KBr crystal until completely covered with the experimental coating at a thickness not exceeding 1.0 micron. The sample was scanned using 100 co-added scans and the spectrum is converted to absorbance. The net peak area of the acrylate absorbance at 810 cm⁻¹ of the liquid coating was then measured.

The net peak area was measured using the “baseline” technique in which a baseline is drawn tangent to absorbance minima on either side of the peak. The area under the peak and above the baseline was then determined.

The sample was exposed to a 100 W mercury lamp (model 6281 from Oriel Corp.) in an air atmosphere. The FTIR scan of the sample and the measurement of net peak absorbance for the spectrum of the cured coating are repeated. Baseline frequencies are not necessarily the same as those of the liquid coating, but were chosen such that the baseline was still tangent to the absorbance minima on either side of the analytical band. The peak area measurement for a non-acrylate reference peak of both the liquid and cured coating spectrum is repeated. For each subsequent analysis of the same formulation, the same reference peak, with the same baseline points, was utilized.

The ratio of the acrylate absorbance to the reference absorbance for the liquid coating was determined using the following equation:

$${R}_{L} = \frac{{A}_{AL}}{{A}_{RL}}$$

where
A_{AL}=area of acrylate absorbance of liquid;
A_{RL}=area of reference absorbance of liquid; and
R_{L}=area ratio of liquid.

In a similar manner, the ratio of the acrylate absorbance to the reference absorbance for the cured coating was determined using the equation:

$${R}_{F} = \frac{{A}_{AF}}{{A}_{RF}}$$

where
A_{AF}=area of acrylate absorbance of cured coating;
A_{RF}=area of reference absorbance of cured coating; and
R_{F}=area ratio of cured coating.

The degree of cure as percent-reacted acrylate unsaturation (% RAU) was calculated using the following equation:

$$\% RAU = \frac{( {R}_{L} - {R}_{F} ) \times 100}{{R}_{L}}$$

where
R_{L}=area ratio of liquid; and
R_{F}=area ratio of cured coating.

Some compositions containing an appreciable level of multifunctional acrylates are known to have relatively low % RAU values, even when fully cured (“% Ultimate RAU”), usually on the order of 55-70% RAU.

“% Relative RAU” represents the degree of curing of a coating composition relative to its % Ultimate RAU, and is defined by the following equation:
% Relative RAU=((% RAU of test composition)/(% Ultimate RAU))100.

Having described specific embodiments of the present invention, it will be understood that many modifications thereof will readily appear or may be suggested to those skilled in the art, and it is intended therefore that this invention is limited only by the spirit and scope of the following claims.

1. A radiation curable coating composition comprising, when cured in air, the following properties:
a. a 95% Relative RAU Dose of no greater than 0.7 J/cm² at a coating thickness of less than 1.0 μm;
b. a pencil hardness of greater than or equal to H; and
c. a refractive index of less than 1.55.

2. The coating composition of claim 1, wherein said coating composition has a 95% Relative RAU Dose of no greater than 0.7 J/cm² at a coating thickness of less than 0.8 microns.

3. The coating composition of claim 2, wherein said coating composition has a 95% Relative RAU Dose of no greater than 0.5 J/cm².

4. The coating composition of claim 2, wherein said coating composition has a 95% Relative RAU Dose of no greater than 0.3 J/cm².

5. The coating composition of claim 2, wherein said coating composition has a 95% Relative RAU Dose of no greater than 0.2 J/cm².

6. The coating composition of claim 1 having, after curing in air, a specular reflectance of less than 1.0.

7. The coating composition of claim 1 having, after curing in air, a specular reflectance of less than 0.5.

8. The coating composition of claim 1 having, after curing in air, an ethanol rub value greater than 3.

9. The coating composition of claim 1 having, after curing in air, an ethanol rub value greater than 10.

10. The coating composition of claim 1 having, after curing in air, an ethanol rub value greater than 25.

11. The coating composition of claim 1 having, after curing in air, a total reflectance of less than 2.0.

12. The coating composition of claim 1 having, after curing in air, a total reflectance of less than 1.9.

13. The coating composition of claim 1 having, after curing in air, a total reflectance of less than 1.8.

14. The coating composition of claim 1 having, after curing in air, a hardness greater than H.

15. The coating composition of claim 1 having, after curing in air, a hardness greater than 2H.

16. The coating composition of claim 1 further comprising fluorinated acrylated nanoparticles comprising a metallic oxide or a metalloid oxide.

17. The coating composition of claim 16 wherein said metallic oxide or metalloid oxide is selected from silicon oxide, aluminum oxide, antimony oxide, or mixtures thereof.

18. The coating composition of claim 16 wherein said nanoparticle comprises a metalloid oxide.

19. The coating composition of claim 18 wherein said metalloid oxide is silicon oxide.

20. The coating composition of claim 1 further comprising a fluorinated oligomer.

21. The coating composition of claim 1, further comprising 2-methyl-1-[4-(methylthio)phenyl]-2-morpholino propan-1-one.

22. The coating composition of claim 1 further comprising one or more photoinitiators, wherein the total quantity of said one or more photoinitiators is at least 6.0 wt. % relative to the total weight of the composition excluding solvent.

23. The coating composition of claim 1 further comprising one or more photoinitiators, wherein the total quantity of said one or more photoinitiators is at least 8.0 wt. % relative to the total weight of the composition excluding solvent.

24. The coating composition of claim 1 further comprising at least one cure enhancing agent.

25. The coating composition of claim 24 wherein said at least one cure enhancing agent is selected from a diamine, a phosphine or a phosphite.

26. The coating composition of claim 25 wherein said at least one cure enhancing agent includes a diamine.

27. The coating composition of claim 26 wherein said diamine includes N,N,N-triethyl ethylene diamine.

28. The coating composition of claim 1 further comprising a polymeric surfactant.

29. The coating composition of claim 28 wherein said polymeric surfactant has a Tg greater than 70° C.

30. The coating composition of claim 28 wherein said polymeric surfactant is cellulose acetate butyrate.

31. The coating composition of claim 28 wherein said polymeric surfactant is [Elvacite 2669].

32. The coating composition of claim 28 wherein said polymeric surfactant is [Elvacite 2008].

33. A radiation curable coating composition comprising:
a. an acrylate having greater than 2 acrylate groups;
b. at least one component having at least one covalent fluorine bond; and
c. one or more photoinitiators
wherein the total quantity of the photoinitiator in said composition is at least 6 wt. % relative to the total weight of the composition excluding solvent.

34. The coating composition of claim 33 said acrylate having greater than 3 acrylate groups.

35. The coating composition of claim 33 said acrylate having greater than 4 acrylate groups.

36. The coating composition of claim 33 wherein said acrylate is pentaerythritol tetracrylate.

37. The coating composition of claim 33 wherein said acrylate is dipentaerythritol pentaacrylate.

38. The coating composition of claim 37 wherein said dipentaerythritol pentacrylate comprises between 3 and 25 wt. % relative to the total weight of the composition excluding solvent.

39. The coating composition of claim 33 further comprising nanoparticles comprised of a metallic oxide or a metalloid oxide.

40. The coating composition of claim 33 wherein said nanoparticles comprise silicon oxide.

41. The coating composition of claim 33 wherein said at least one component having at least one covalent fluorine bond is a nanoparticle having a fluorinated acrylated moiety.

42. The coating composition of claim 33 wherein said at least one component having at least one covalent fluorine bond is a fluorinated oligomer.

43. The coating composition of claim 33 wherein said one or more photoinitiators includes 2-methyl-1-[4-(methylthio)phenyl]-2-morpholino propan-1-one.

44. The coating composition of claim 33 wherein said one ore more photoinitiators comprises at least 8.0 wt. % relative to the total weight of the composition excluding solvent.

45. The coating composition of claim 33 further comprising at least one cure enhancing agent.

46. The coating composition of claim 45 wherein said at least one cure enhancing agent is selected from a diamine, a phosphine, or a phosphite.

47. An antireflective system comprising a coating obtained by curing the composition of claim 33.

48. An antireflective coating system comprising:
a. a high refractive index coating; and
b. the low refractive index coating composition of claim 35.

49. The antireflective coating system of claim 48 said high refractive index coating having, upon curing in air, a refractive index of at least 1.58.

50. The antireflective coating system of claim 48 said low refractive index coating having, upon curing in air, a refractive index of 1.55 or less.

51. An article comprising a low refractive index coating obtained by curing the composition of claim 33.

52. The article of claim 51 further comprising a high refractive index coating.

53. The article of claim 52 further comprising:
a. a substrate; and
b. a hardcoat layer;
wherein said hardcoat layer is coated directly on said substrate and said high refractive index coating is on the hardcoat layer.

54. The article of claim 51 wherein said article is an antireflective display panel.

55. A process for preparing a low refractive index coating composition comprising:
mixing:
a. an acrylate having greater than 2 acrylate groups;
b. at least one component having at least one covalent fluorine bond; and
C. one or more photoinitiators
wherein the total quantity of the photoinitiator in said composition is at least 6 wt. % relative to the total weight of the composition excluding solvent.

56. A method of making a fast-curing, thin, low-refractive index coating composition comprising:
mixing:
a. an acrylate having greater than 2 acrylate groups;
b. at least one component having at least one covalent fluorine bond; and
c. one or more photoinitiators
wherein the total quantity of the photoinitiator in said composition is at least 6 wt. % relative to the total weight of the composition excluding solvent.
